(19) United States
(12) Patent Application Publication
(10) Pub. No.: US 2018/0342262 A1
(43) Pub. Date: Nov. 29, 2018

(54) MAGNETIC RECORDING HEAD AND DISK DEVICE COMPRISING THE SAME

(71) Applicants: Kabushiki Kaisha Toshiba, Tokyo (JP); Toshiba Electronic Devices & Storage Corporation, Tokyo (JP)

(72) Inventor: Takuya Matsumoto, Tokyo (JP)

(21) Appl. No.: 15/875,281

(22) Filed: Jan. 19, 2018

(30) Foreign Application Priority Data
May 23, 2017 (JP) 2017-101910

(51) Int. Cl. G11B 5/11; G11B 5/73

(52) U.S. Cl. CPC G11B 5/11; G11B 5/73

(57) ABSTRACT

According to an embodiment, a magnetic head includes a magnetoresistive element, a first magnetic shield and a second magnetic shield provided on a trailing side and a leading side of the magnetoresistive element in a down-track direction, and side shields on both sides of the magnetoresistive element, respectively, in a track-width direction. At least one of the side shields includes a trailing-side portion having magnetic permeability and a leading-side portion having magnetic permeability different from that of the trailing-side portion.

### CROSS-REFERENCE TO RELATED APPLICATIONS

This application is based upon and claims the benefit of priority from Japanese Patent Application No. 2017-101910, filed May 23, 2017, the entire contents of which are incorporated herein by reference.

### FIELD

Embodiments described herein relate generally to a magnetic head and a disk device comprising the magnetic head.

### BACKGROUND

As a disk device, a magnetic disk drive comprises a disk-shaped recording medium, that is, a magnetic disk, which is disposed in a case, and a magnetic head which reads and writes information from and to the magnetic disk. The magnetic head includes, for example, a recording head and a reproducing head (reproducing element).

Because of the shape of the main magnetic pole of the recording head, the distribution of a magnetic field in the vicinity of the edge of the main magnetic pole is not perpendicular to a down-track direction, but is curved. That is, at the time of magnetic recording, the strength and gradient of a magnetic field produced from the recording head deteriorate toward a track edge portion. Thus, the transition shape of a recorded magnetization pattern on the magnetic disk is a curved shape.

If such a recorded magnetization pattern having a curved transition shape is reproduced by the reproducing head, the quality of a reproduction signal deteriorates because the distribution of reproduction sensitivity of the reproducing head and the shape of the magnetization pattern on the magnetic disk are different. The deterioration of the quality at the time of reproduction is ever more greatly affected by a high linear density of a magnetization pattern and a higher track pitch. Although a method of reducing the size of the reproducing element of the reproducing head so as to avoid a curved portion is conceivable, there is a limit on reductions in size in terms of a manufacturing process and the deterioration of output.

### BRIEF DESCRIPTION OF THE DRAWINGS

FIG. 1 is a block diagram schematically showing a hard disk drive (HDD) according to an embodiment.

FIG. 2 is a side view showing a magnetic head, a suspension, and a magnetic disk in the HDD.

FIG. 3 is an enlarged sectional view of a head portion of the magnetic head.

FIG. 4 is a plan view showing the head portion of the magnetic head from the perspective of an ABS.

FIG. 5 is an enlarged sectional view of reproducing head of the magnetic head.

FIG. 6 is a diagram showing an example of a recorded pattern on the magnetic disk.

FIG. 7 is a diagram showing the distribution of reproduction sensitivity of the reproducing head according to the embodiment, and the distribution of reproduction sensitivity of a reproducing head according to a comparative example.

FIG. 8 is a diagram showing a comparison between an SN ratio of a reproduction signal of the reproducing head according to the embodiment and an SN ratio of a reproduction signal of the reproducing head according to the comparative example.

### DETAILED DESCRIPTION

Various embodiments will be described hereinafter with reference to the accompanying drawings. In general, according to one embodiment, a magnetic head comprises: a magnetoresistive element; a first magnetic shield and a second magnetic shield provided on a trailing side and a leading side of the magnetoresistive element in a down-track direction; and side shields on both sides of the magnetoresistive element, respectively, in a track-width direction. At least one of the side shields includes a trailing-side portion having magnetic permeability and a leading-side portion having magnetic permeability different from that of the trailing-side portion.

The disclosure is merely an example, and proper changes in keeping with the spirit of the invention, which are easily conceivable by a person with ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

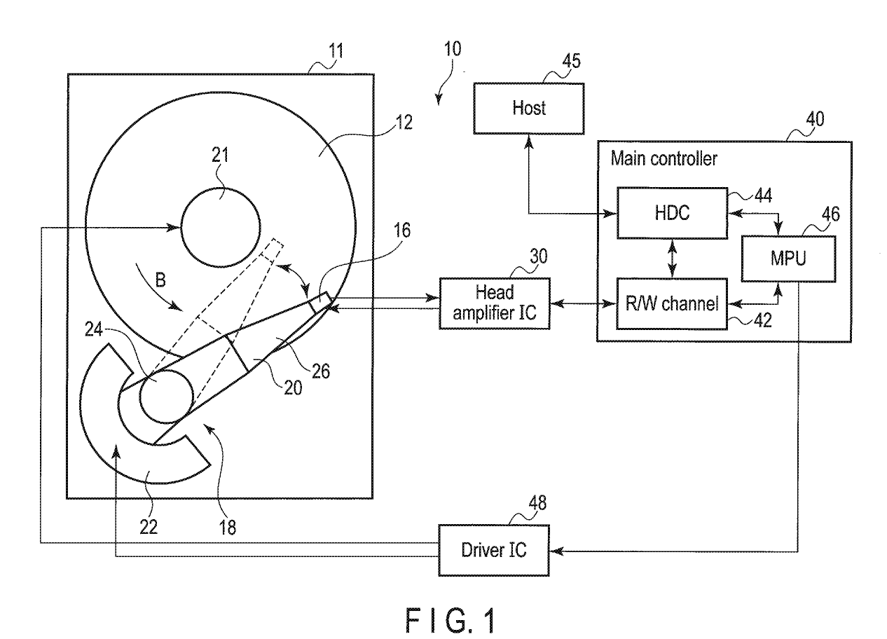

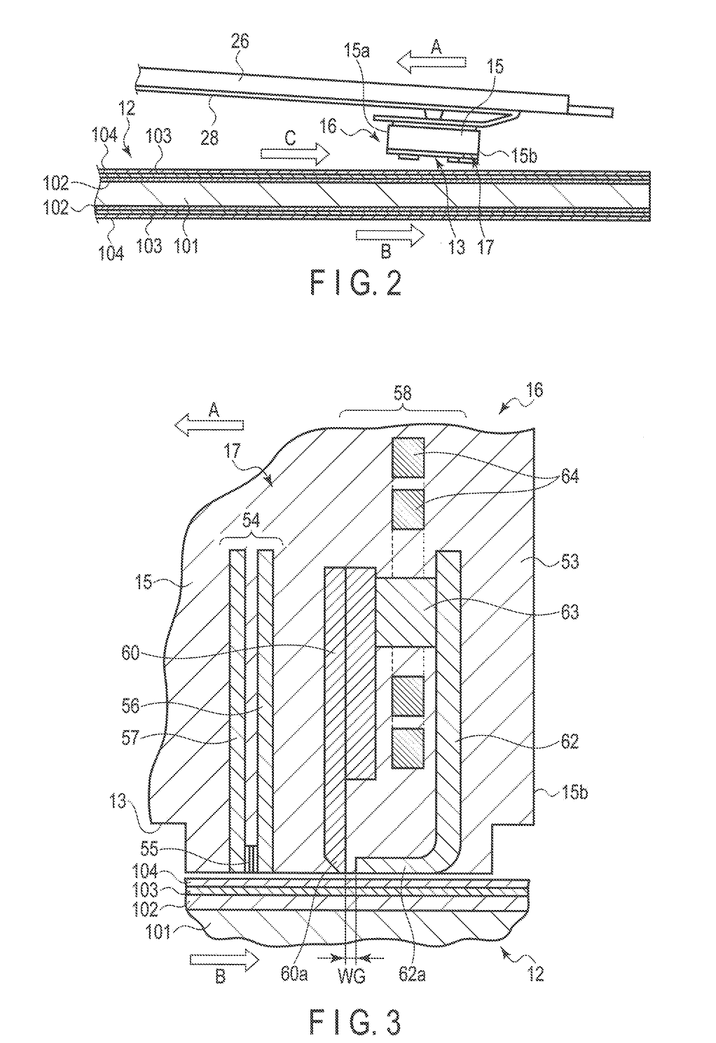

A hard disk drive (HDD) according to an embodiment as a disk device will be described in detail. FIG. 1 is a block diagram schematically showing the HDD according to the embodiment. FIG. 2 is a side view showing a magnetic head in a flying state and a magnetic disk.

As shown in FIG. 1, the HDD 10 comprises a rectangular housing 11, a magnetic disk 12 as a recording medium disposed in the housing 11, a spindle motor 21 which supports and rotates the magnetic disk 12, and magnetic heads 16 which write and read data to and from the magnetic disk 12. The HDD 10 comprises a head actuator 18 which moves the magnetic heads 16 to above an arbitrary track on the magnetic disk 12 and positions the magnetic heads 16. The head actuator 18 comprises a carriage assembly 20 which supports the magnetic heads 16, such that the magnetic heads 16 are movable, and a voice coil motor (VCM) 22 which rotates the carriage assembly 20.

The HDD 10 comprises a head amplifier IC 30, a main controller 40, and a driver IC 48. The head amplifier IC 30 is, for example, provided in the carriage assembly 20, and electrically connected to the magnetic heads 16. The main controller 40 and the driver IC 48 are, for example, formed on a control circuit board, which is not shown in the figures, provided on the rear surface side of the housing 11. The main controller 40 comprises an R/W channel 42, a hard disk controller (HDC) 44, and a microprocessor (MPU) 46. The main controller 40 is electrically connected to the magnetic heads 16 via the head amplifier IC 30. In addition, the main controller 40 is electrically connected to the VCM 22 and the spindle motor 21 via the driver IC 48. The HDC 44 is connectable to a host computer 45.

As shown in FIG. 1 and FIG. 2, the magnetic disk 12 is a perpendicular magnetic recording medium. The magnetic disk 12 comprises a substrate 101 which is formed of a nonmagnetic material in the shape of a disk having a diameter of approximately 2.5 inches (6.35 cm), for example. A soft magnetic layer 102 made of a material exhibiting a soft magnetic property as an underlayer, a perpendicular magnetic recording layer 103 having magnetic anisotropy in a direction perpendicular to the surface of the magnetic disk 12, and a protective film 104 are stacked in order on each surface of the substrate 101. The magnetic disk 12 is fitted to the hub of the spindle motor 21, such that they are coaxial with each other. The magnetic disk 12 is rotated by the spindle motor 21 at a predetermined speed in a direction pointed by an arrow B.

The carriage assembly 20 comprises a bearing unit 24 rotatably fixed to the housing 11 and suspensions 26 extending from the bearing unit 24. As shown in FIG. 2, the magnetic heads 16 are supported by extending ends of the respective suspensions 26. The magnetic heads 16 are electrically connected to the head amplifier IC 30 via a wiring member 28 provided on the carriage assembly 20.

As shown in FIG. 2, each of the magnetic heads 16 is formed as a flying-type head, and comprises a slider 15 formed in a substantially rectangular parallelepiped shape and a head portion 17 formed at an end portion on the outflow end (trailing) side of the slider 15. The slider 15 is formed of, for example, a sintered body of alumina and titanium carbide (AlTiC). The head portion 17 is formed of a plurality of thin films.

The slider 15 has a rectangular disk facing surface (medium facing surface or air bearing surface [ABS]) 13 facing the surface of the magnetic disk 12. The slider 15 is kept flying at a predetermined distance from the surface of the magnetic disk 12, because of an airflow C produced between the disk surface and the ABS 13 by the rotation of the magnetic disk 12. The direction of the airflow C coincides with the direction of rotation B of the magnetic disk 12. The slider 15 comprises a leading end 15a located on the inflow side of the airflow C, and a trailing end 15b located on the outflow side of the airflow C. With the rotation of the magnetic disk 12, the magnetic heads 16 travel above the magnetic disk 12 in a direction pointed by an arrow A (head-travel direction), that is, the opposite direction to the direction of rotation B of the disk.

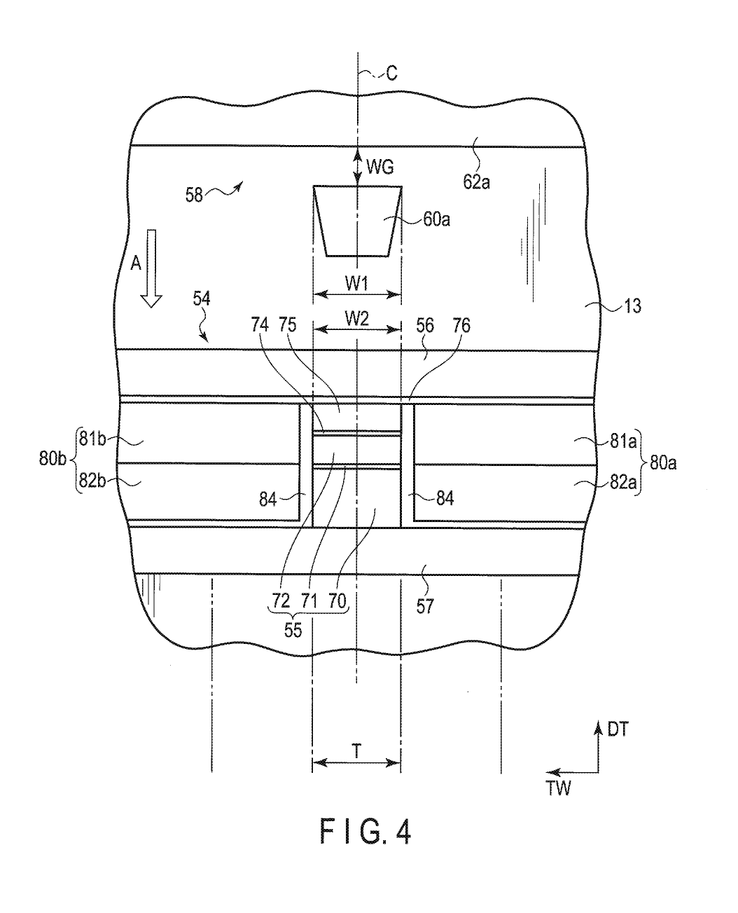

FIG. 3 is an enlarged sectional view of the head portion 17. FIG. 4 is an expanded plan view showing the head portion of the magnetic head from the perspective of the ABS. The head portion 17 of each of the magnetic heads 16 comprises a reproducing head (read head) 54 and a recording head 58 formed at the trailing end 15b of the slider 15 by a thin-film process, and is formed as a separation-type magnetic head. The reproducing head 54 and the recording head 58 except for portions exposed at the ABS 13 of the slider 15 are covered by a nonmagnetic protective insulating film 53. The protective insulating film 53 forms the outer shape of the head portion 17.

The recording head 58 is provided on the trailing end 15b side of the slider 15 with respect to the reproducing head 54. The recording head 58 comprises a main magnetic pole 60 which produces a recording magnetic field in a direction perpendicular to the ABS 13, a write shield 62 facing the main magnetic pole 60 with a write gap WG therebetween, a junction 63 physically joining an upper portion of the main magnetic pole 60 to the write shield 62, a recording coil 64 wound around a magnetic core consisting of the main magnetic pole 60 and the write shield 62, etc. The main magnetic pole 60 is formed of a soft magnetic material having high magnetic permeability and high saturation magnetic flux density, and its tip portion 60a is exposed at the ABS 13. The write shield 62 is formed of a soft magnetic material, and its tip portion 62a is exposed at the ABS 13. The main magnetic pole 60 and the write shield 62 are arranged in a longitudinal axis (central axis C) of the slider 15 and in the head-travel direction A. As shown in FIG. 4, the width (width in a track-width direction TW) W1 of the tip portion 60a of the main magnetic pole 60 is set to be equal to or less than the width T of a track on the magnetic disk 12.

As shown in FIG. 3 and FIG. 4, the reproducing head 54 is provided on the leading side of the recording head 58, that is, on the inflow side. The reproducing head 54 comprises a magnetoresistive element 55, a first magnetic shield film 56 and a second magnetic shield film 57 which are disposed on the trailing side (outflow side) and the leading side (inflow side) of the magnetoresistive element 55 in a down-track direction DT with the magnetoresistive element 55 interposed therebetween, and side shields 80a and 80b. The magnetoresistive element 55, the first and second magnetic shield films 56 and 57, and the side shields 80a and 80b extend to be substantially perpendicular to the ABS 13. The lower ends of the magnetoresistive element 55, the first and second magnetic shield films 56 and 57, and the side shields 80a and 80b are exposed at the ABS 13.

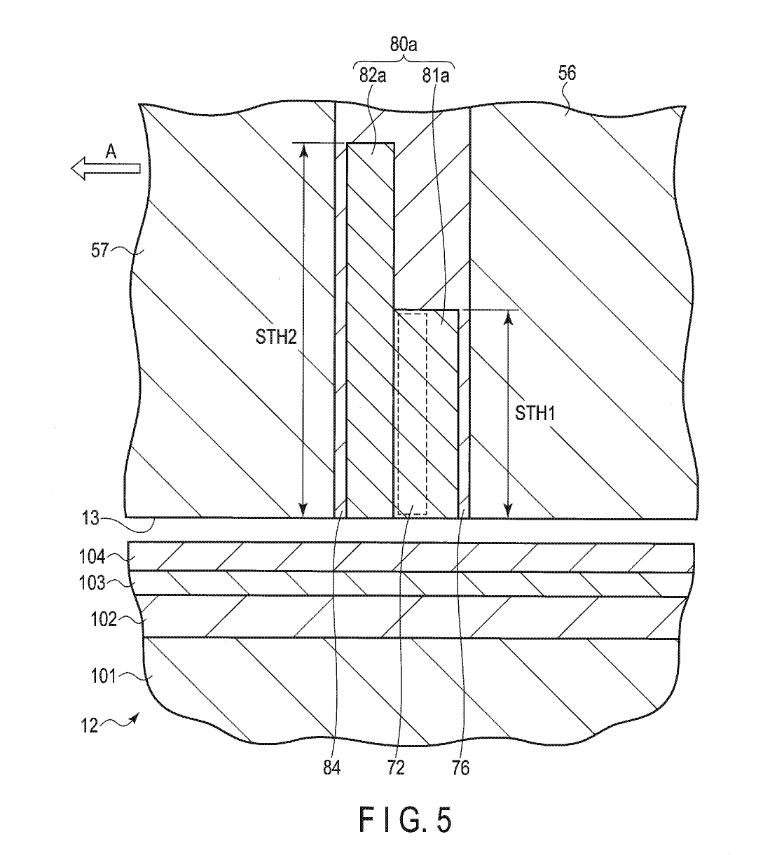

FIG. 5 is an enlarged sectional view showing the tip portion of the reproducing head. As shown in FIG. 4 and FIG. 5, the magnetoresistive element 55 comprises a first magnetic layer (pinned layer) 70 having a fixed direction of magnetization, an insulating layer 71 provided on the pinned layer 70, and a second magnetic layer (free layer) 72 provided on the insulating layer 71 and having a direction of magnetization varying according to an external magnetic field. The pinned layer 70 is provided to face the second magnetic shield film 57. The free layer 72 is provided on the insulating layer 71 between the pinned layer 70 and the first magnetic shield film 56. A nonmagnetic layer 74 and a nonmagnetic cap layer 75 are stacked in order on the free layer 72. Further, the nonmagnetic cap layer 75 is in contact with the first magnetic shield film 56 via a nonmagnetic layer 76. The width W2 in the track-width direction TW of the magnetoresistive element 55 is set to be less than or equal to the width T of a track on the magnetic disk 12.

The side shields 80a and 80b are provided on both sides of the magnetoresistive element 55, respectively, in the track-width direction TW. An insulating layer 84 is provided between the side shields 80a and 80b and the magnetoresistive element 55, and between the side shields 80a and 80b and the second magnetic shield film 57. The leading sides (inflow sides) of the side shields 80a and 80b are in contact with the second magnetic shield film 57 via the insulating layer 84. The trailing sides (outflow sides) of the side shields 80a and 80b are in contact with the first magnetic shield film 56 via the nonmagnetic layer 76. At least one of the side shields 80a and 80b has magnetic permeability which varies between the leading sides and the trailing sides of the side shields.

In the present embodiment, the side shield 80a comprises a first side shield layer 81a located on the trailing side (outflow side or recording head side) and a second side shield layer 82a located on the leading side (inflow side). In the down-track direction DT, the border between the first side shield layer 81a and the second side shield layer 82a substantially aligns with the border between the free layer 72 and the pinned layer 70 of the magnetoresistive element 55. Thus, the first side shield layer 81a faces the free layer 72 and the nonmagnetic cap layer 75, and the second side shield layer 82a faces the pinned layer 70. The magnetic permeability μ1 of the first side shield layer 81a and the magnetic permeability μ2 of the second side shield layer 82a are different from each other. Here, the magnetic permeability μ2 is greater than the magnetic permeability μ1 (∥1<μ2).

Similarly, the side shield 80b comprises a first side shield layer 81b located on the trailing side (outflow side or recording head side) and a second side shield layer 82b located on the leading side (inflow side). In the down-track direction DT, the border between the first side shield layer 81b and the second side shield layer 82b substantially aligns with the border between the free layer 72 and the pinned layer 70. Thus, the first side shield layer 81b faces the free layer 72 and the nonmagnetic cap layer 75, and the second side shield layer 82b faces the pinned layer 70. The magnetic permeability μ1 of the first side shield layer 81b and the magnetic permeability μ2 of the second side shield layer 82b are different from each other. Here, the magnetic permeability μ2 is greater than the magnetic permeability μ1 (μ1<μ2).

According to the present embodiment, the first side shield layers 81a and 81b and the second side shield layers 82a and 82b are formed of magnetic materials differing from each other so that the magnetic permeability μ1 is less than the magnetic permeability μ2. The magnetic permeability μ1 is made less than the magnetic permeability μ2 by using, for example, NiFe, CoFe, CoZrTa, or CoZrNb, and for example, changing the content of Ni in FeNi, adding Mb, Cu, Cr, etc., or using different materials, for the first side shield layers 81a and 81b and the second side shield layers 82a and 82b.

In addition, the first side shield layers 81a and 81b and the second side shield layers 82a and 82b may be formed of the same magnetic materials. In the present embodiment, as shown in FIG. 5, the first side shield layers 81a and 81b and the second side shield layers 82a and 82b are formed, such that STH1<STH2, where STH1 is the height of the first side shield layers 81a and 81b (height in a direction perpendicular to the ABS 13), and STH2 is the height of the second side shield layers 82a and 82b. The height STH1 of the first side shield layers 81a and 81b is set to be less than or equal to the height of the free layer 72.

The function of the above-described magnetic heads will be described.

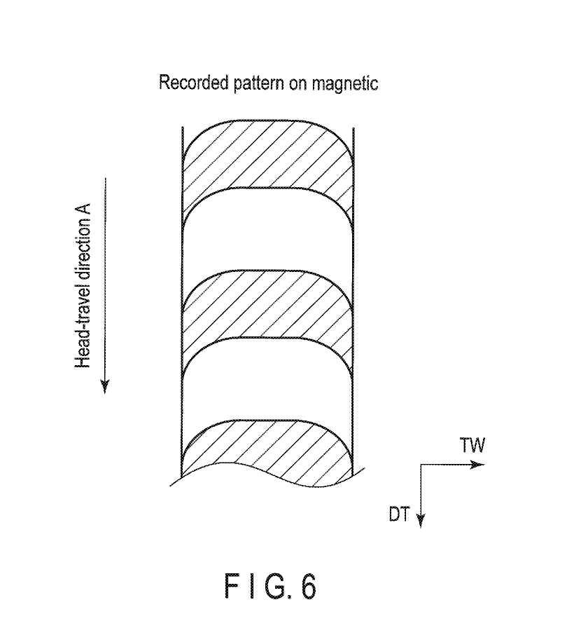

FIG. 6 is a diagram schematically showing an example of a recorded magnetization pattern recorded on the magnetic disk 12. The strength and gradient of a magnetic field produced from the recording head 58 deteriorate toward track edge portions. Thus, as shown in the figure, the transition shape of the recorded magnetization pattern on the magnetic disk 12 has a shape curved at the track edge portions.

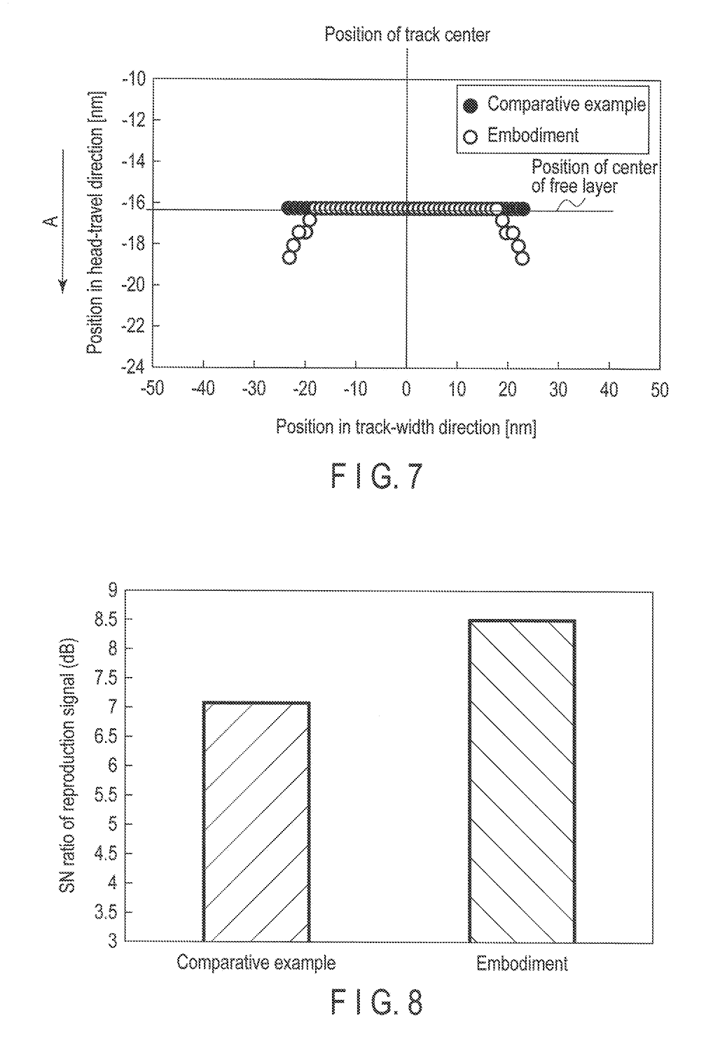

FIG. 7 shows the distribution of reproduction sensitivity of the reproducing head 54 according to the embodiment and the distribution of reproduction sensitivity of a reproducing head according to a comparative example. In the present embodiment, the physical width of the free layer is 40 nm, and the film thickness thereof is 5 nm. The side shields are formed, such that the magnetic permeability μ1 of the side shield layers 81a and 81b disposed on the trailing side is less than the magnetic permeability μ2 of the side shield layers 82a and 82b disposed on the leading side. In contrast, in the reproducing head according to the comparative example, the magnetic permeability of side shields is set constant between the leading side and the trailing side.

In FIG. 7, the positions in the head-travel direction A where the reproduction sensitivity of the reproducing heads is the greatest in the respective track-width positions are each plotted based on the calculated distributions of reproduction sensitivity of the reproducing heads. Black dots indicate a profile of the reproducing head according to the comparative example, and white dots indicate a profile of the reproducing head according to the present embodiment. In both the comparative example and the embodiment, the free layer of the reproducing head is located at a head travel position of 16 nm.

As indicated by the black dots, the positions where the reproduction sensitivity is the greatest of the reproducing head according to the comparative example extend straight in the track-width direction along the position of the free layer. In contrast, as indicated by the white dots, regarding the reproducing head according to the present embodiment, the reproduction sensitivity of the reproducing head is the greatest along the position of the free layer in the vicinity of the track center, but as it deviates from the track center, the positions in the head-travel direction where the reproduction sensitivity of the reproducing head is the greatest shift to the leading side (inflow side). In this manner, with the reproducing head according to the present embodiment, the distribution of reproduction sensitivity can be curved to the leading side at track edge portions, and can be made closer to the shape of a recorded magnetization pattern on the magnetic disk 12 as shown in FIG. 6. Therefore, with the reproducing head according to the present embodiment, a magnetic magnetization pattern can be read with high accuracy, even if the recorded magnetization pattern is curved.

FIG. 8 shows a comparison between an SN ratio of a reproduction signal of the reproducing head according to the embodiment and an SN ratio of a reproduction signal of the reproducing head according to the comparative example in the case where a single recorded magnetization pattern is read. From this figure, it is understood that the SN ratio of the reproduction signal of the reproducing head according to the present embodiment is better than that of the comparative example by approximately 1.5 dB, and the quality of signals at the time of reproduction is improved.

With the above-described HDD and magnetic heads, the magnetic permeability of the side shields of the reproducing head varies between the trailing side and the leading side, whereby the distribution of reproduction sensitivity can be made closer to the shape of magnetization transition. This makes it possible to obtain a magnetic head and a disk device comprising the magnetic head, wherein the deterioration of the quality of signals at the time of reproduction is prevented, so that the quality of signals can be improved and recording can be performed at high density.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, side shields of a reproducing head are not necessarily formed of two layers, and three or more side shield layers can be used. Moreover, side shields may be formed of one layer whose volume increases from the trailing side to the leading side. Moreover, the magnetic permeability of both side shields does not necessarily vary, and only one of the side shields may have magnetic permeability varying between the trailing side and the leading side. Also in this case, the quality of signals can be improved. The materials, shapes, sizes, etc., of elements which constitute the disk device are not limited to those in the above-described embodiments, and can be changed variously as needed.

What is claimed is:

1. A magnetic head comprising:
a magnetoresistive element;
a first magnetic shield and a second magnetic shield provided on a trailing side and a leading side of the magnetoresistive element in a down-track direction; and
side shields on both sides of the magnetoresistive element, respectively, in a track-width direction, at least one of the side shields including a trailing-side portion having magnetic permeability and a leading-side portion having magnetic permeability different from that of the trailing-side portion.

2. The magnetic head of claim 1, wherein the magnetoresistive element comprises a first magnetic layer provided to be adjacent to the second magnetic shield and having a fixed direction of magnetization, and a second magnetic layer provided on a trailing side of the first magnetic layer and having a variable direction of magnetization.

3. The magnetic head of claim 2, wherein the trailing-side portion of the at least one of the side shields has first magnetic permeability, and
the leading-side portion of the at least one of the side shields has second magnetic permeability greater than the first magnetic permeability.

4. The magnetic head of claim 2, wherein each of the side shields includes a first side shield layer provided on the first magnetic shield side, and a second side shield layer provided on the second magnetic shield side, and
first magnetic permeability of the first side shield layer and second magnetic permeability of the second side shield layer are different.

5. The magnetic head of claim 4, wherein the second magnetic permeability is greater than the first magnetic permeability.

6. The magnetic head of claim 5, further comprising a disk facing surface at which the magnetoresistive element, the first side shield layer, and the second side shield layer are exposed, and
a height of the second side shield layer above the disk facing surface is greater than a height of the first side shield layer above the disk facing surface.

7. The magnetic head of claim 6, wherein the first side shield layer and the second side shield layer are disposed to face the second magnetic layer and the first magnetic layer, respectively.

8. The magnetic head of claim 4, wherein the first side shield layer and the second side shield layer are disposed to face the second magnetic layer and the first magnetic layer, respectively.

9. A disk device comprising:
a disk-shaped recording medium; and
the magnetic head of claim 1, which reproduces information on the recording medium.

10. The disk device of claim 9, wherein the recording medium comprises a soft magnetic layer, and a magnetic recording layer on the soft magnetic layer, having magnetic anisotropy perpendicular to a surface of the recording medium.

11. The disk device of claim 9, wherein the magnetoresistive element comprises a first magnetic layer provided to be adjacent to the second magnetic shield and having a fixed direction of magnetization, and a second magnetic layer on a trailing side of the first magnetic layer, having a variable direction of magnetization.

12. The disk device of claim 11, wherein
the trailing-side portion of the at least one of the side shields has first magnetic permeability, and
the leading-side portion of the at least one of the side shields has second magnetic permeability greater than the first magnetic permeability.

13. The disk device of claim 12, wherein each of the side shields includes a first side shield layer provided on the first magnetic shield side, and a second side shield layer provided on the second magnetic shield side, and
the first magnetic permeability of the first side shield layer and the second magnetic permeability of the second side shield layer are different.
